(19) United States
(12) Patent Application Publication
(10) Pub. No.: US 2008/0252129 A1
(43) Pub. Date: Oct. 16, 2008

(54) SEAT FOLD ACTUATOR

(75) Inventors: John F. Nathan, Highland, MI (US); H. Winston Maue, Northville, MI (US)

Correspondence Address: BROOKS KUSHMAN P.C. / LEAR CORPORATION, 1000 TOWN CENTER, TWENTY-SECOND FLOOR, SOUTHFIELD, MI, 48075-1238, US

(73) Assignee: LEAR CORPORATION, Southfield, MI (US)

(21) Appl. No.: 11/734,950

(22) Filed: Apr. 13, 2007

(51) Int. Cl. B60N 2/02

(52) U.S. Cl. 297/378.11

(57) ABSTRACT

A linear actuator configured to move multiple mechanisms in different directions along a common axis. The actuator suitable for use in any number of applications and environments, including but not limited to vehicle seat applications where a latch handle or other features requires actuation in order to facilitate folding the seat from an upright position to a fold-flat position and onto a tumble position.

### BACKGROUND OF THE INVENTION

1. Field of the Invention

The present invention relates to seat fold actuators.

2. Background Art

Actuators and triggers are devices that cause or otherwise induce an apparatus to operate or execute a related function. Latches are devices that are used to grasp or lock an object, as with a catch and a lever, or the like. An actuator may be used to release or engage a latch. Some actuators may be remotely connected to a latch to allow for operation of the latch from a distance.

Latches are used in a wide variety of applications. For example, latches may be provided as a part of a machine, on building doors or windows, or in vehicles. Latches that can be reset have the advantage that they can be used repeatedly. One way to provide a latch that can be reset is to provide an actuator that operates a motor and gear reducer to release the latch by forward rotation of the motor and reset the latch by reverse rotation of the motor. While this approach is effective, the cost of a motor and gear reducer may be uneconomical in many applications.

In some applications, it may be desirable to provide a manual actuator and a power actuator for a latch that may be alternatively used to operate the latch. Dual mode actuators may be provided to allow a latch to be manually operated or power operated. One problem with such dual actuation latches is that one mode of actuation may interfere with the other mode. In addition, resetting the dual mode actuator may be complicated if both modes of actuation are not accommodated by the reset mechanism.

One exemplary application for a dual mode remotely actuated latch is a vehicle seat back folding apparatus. Vehicle seat backs may be folded over the seat base to facilitate ingress and egress. Prior art actuators have been developed that use a motor that drives a gear reducer in one direction to release a latch and driven in the opposite direction to reset the actuator for reuse after the latch is engaged. Seat folding latches may also be specified to be manually actuated in the event that a user wishes to operate the latch manually or if power is not available for the power actuation system. While these types of systems have been developed, the cost of the motor and gear reducer may make such systems uneconomical.

### BRIEF DESCRIPTION OF THE DRAWINGS

The present invention is pointed out with particularity in the appended claims. However, other features of the present invention will become more apparent and the present invention will be best understood by referring to the following detailed description in conjunction with the accompany drawings in which:

FIG. 1 illustrates a vehicle seat in accordance with one non-limiting aspect of the present invention;

FIG. 2 illustrates a seat support system in accordance with one non-limiting aspect of the present invention;

FIGS. 3-6 illustrate operation of the seat in accordance with one non-limiting aspect of the present invention;

FIGS. 7a-7f illustrate the actuator in accordance with one non-limiting aspect of the present invention; and

FIG. 8 illustrates a single release mechanism actuator in accordance with one non-limiting aspect of the present invention.

### DETAILED DESCRIPTION OF THE PREFERRED EMBODIMENT(S)

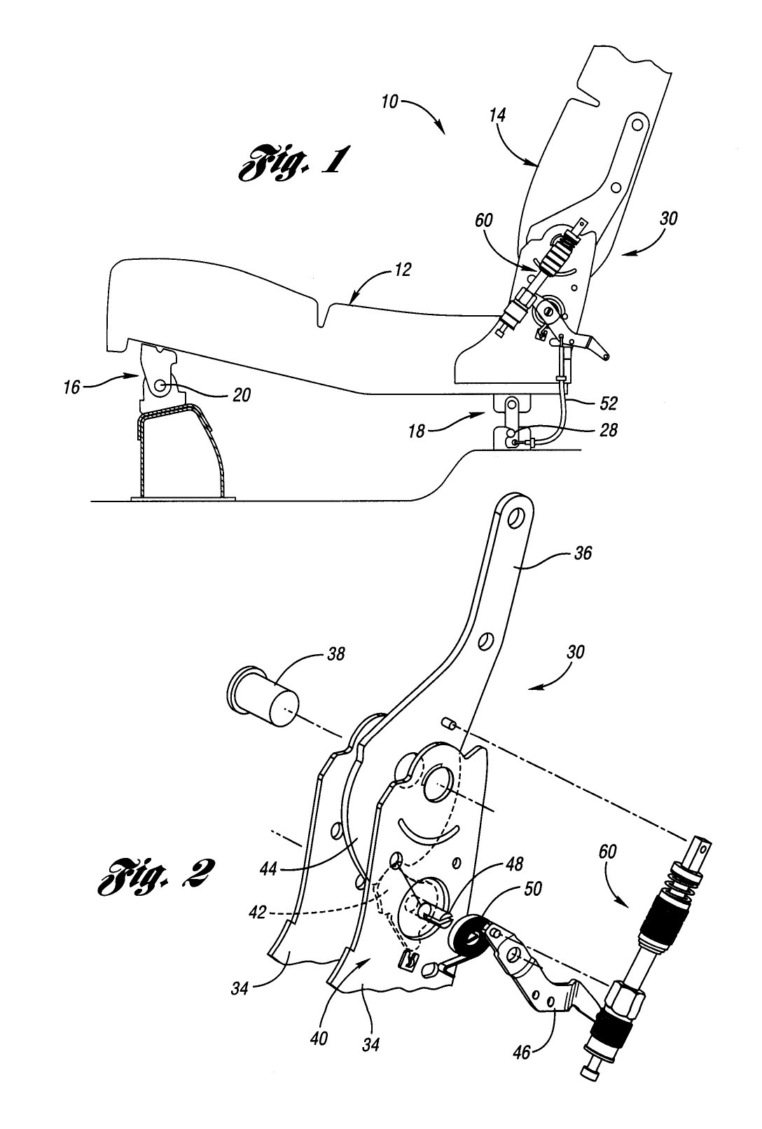

FIG. 1 illustrates a vehicle seat 10 in accordance with one non-limiting aspect of the present invention. The vehicle seat 10 may be configured to fold from an upright position, to a fold-flat position, and then onto a tumble position. This type of vehicle seat 10 may be employed in any number of vehicles to facilitate accessing rear row seating or to facilitate any number of other functions. The vehicle seat 10 may be of the type described in U.S. patent applications entitled “Seat Fold Actuator,” filed on Jun. 21, 2006 and assigned Ser. No. 11/472,203, or “Latch Actuator System,” filed on Mar. 31, 2006 and assigned Ser. No. 11/278,295, the disclosures of both are hereby incorporated in their entirety. The present invention is predominately describe with respect to a vehicle seat for exemplary purposes only. The present invention fully contemplates its application to and use in any number of environments and is not intended to be limited by the exemplary description provided herein.

The vehicle seat 10 may include a seat bottom 12 and seat back 14. The seat back 14 may be positioned relative to the seat bottom 12 to support an occupant. Front and rear floor supports 16-18 may be included to facilitate supporting the seat bottom 12 relative to a vehicle floor or other surface upon which the seat 140 may rest. The front support 16 may include a pivot and spring arrangement 20 or other similar arrangement that allows the seat bottom 12, and thereby, the seat back 14 to automatically rotate about the pivot 20. The rear support 18 may include a releasable floor latch 22 configured to secure the rear portion of the seat bottom 12 to the rear floor support 18 when locked and to permit disengage from the rear support 18 and rotation about the front support 16 when unlocked. These features are shown for exemplary purposes only and the present invention fully contemplates the seat 10 including more or less of these features, depending its configuration and desired operation.

FIG. 2 illustrates a seat support system 30 in accordance with one non-limiting aspect of the present invention. The seat support system 30 may include a bottom bracket 34 and back bracket 36 connect to the seat bottom 12 and seat back 14. The brackets 34-36 may be connected to a pivot 38 to facilitate rotating the seat back 14 relative to the seat bottom 12. The pivot 38 may be biased with a spring (not shown) or other feature such that the seat back 14 may be automatically rotated in a forward direction about the pivot 38 when not otherwise restricted. This movement may be used to fold the seat back 14 from the upright position to the fold flat position and then the floor latch 22 may be released to facilitate rotating the seat bottom 12 and back 14 about the front support 16 to the upright position.

A latch system 40 may be used to restrict rotation of the seat back 14 about the pivot 38, and thereby, rotation of the seat back 14 about the seat bottom 12. The latch system 40 may include a latch 42 operating in cooperation with a cam 44. The cam 44 may be attached to the back bracket 36 and configured to rotate about the pivot 38 when the latch 42 is lowered away from the cam 44 and to be restrained from rotating about the pivot 38 when the latch 42 is engaged with the cam 44. A latch handle 46 may be included and configured to rotate about a latch pivot 48 to control positioning of the latch 42. An rear portion of the handle 46 may be moved in an upward direction to cause the latch 42 to rotate away from the cam 44 and permit rotation of the seat back 14 about the pivot 38. A handle spring 50 may be include to oppose the handle 46 rotation so as to facilitate re-engaging the latches when the seat is folded back from the tumble or fold-flat positions to the upright position.

A cable 52 may be included on the handle 46 to release the floor latch 22 once the rear portion of the handle 46 is rotate upwardly a sufficient distance (see FIG. 1). The combination of the seat back latch 42 and floor latch 22 disengagement frees the moving elements of the seat 10 to allow the seat back 14 and bottom 12 to move from the upright position, to the fold-flat position, and then onto the tumble position. If the cable 52 is attached to the handle 46 such that it is prevented from releasing the floor latch 22 until after the handle 46 has released the seat back latch 42, the seat movement may occur in a sequential pattern such that the seat 10 is delayed in reaching the tumble position until after is has reached the fold-flat position. While the cable 52 is shown to be connected directly between the handle 46 and the floor latch 22, the cable 52 may be otherwise positioned between other elements of the seat 10 and the floor latch 22 and/or any other configuration may be used to trigger the floor latch 22, either before or after the seat reaches the fold-flat position.

The seat 10 may further include an actuator 60 to facilitate automatically actuating the handle 46 or other feature of the seat 10 associated with controlling or otherwise facilitating the seat folding operations describe above. The actuator 60, for exemplary purposes only and without intending to limit the scope and contemplation of the present invention, may be configured to actuate the handle 46 between the various positions associated with controlling the seat 10 to actuate from the upright position, to the fold-flat position, and onto the tumble position. The actuator 60 may be configured to rotate the handle 46 to a first position associated with releasing the seat back latch (fold-flat) and then onto a second position associated with releasing the floor latch (tumble). The actuator 60 may operate in cooperation with manual actuation of the seat handle 46 such that seat 10 may be folded with either manual seat handle actuation or automotive actuator provided seat handle actuation.

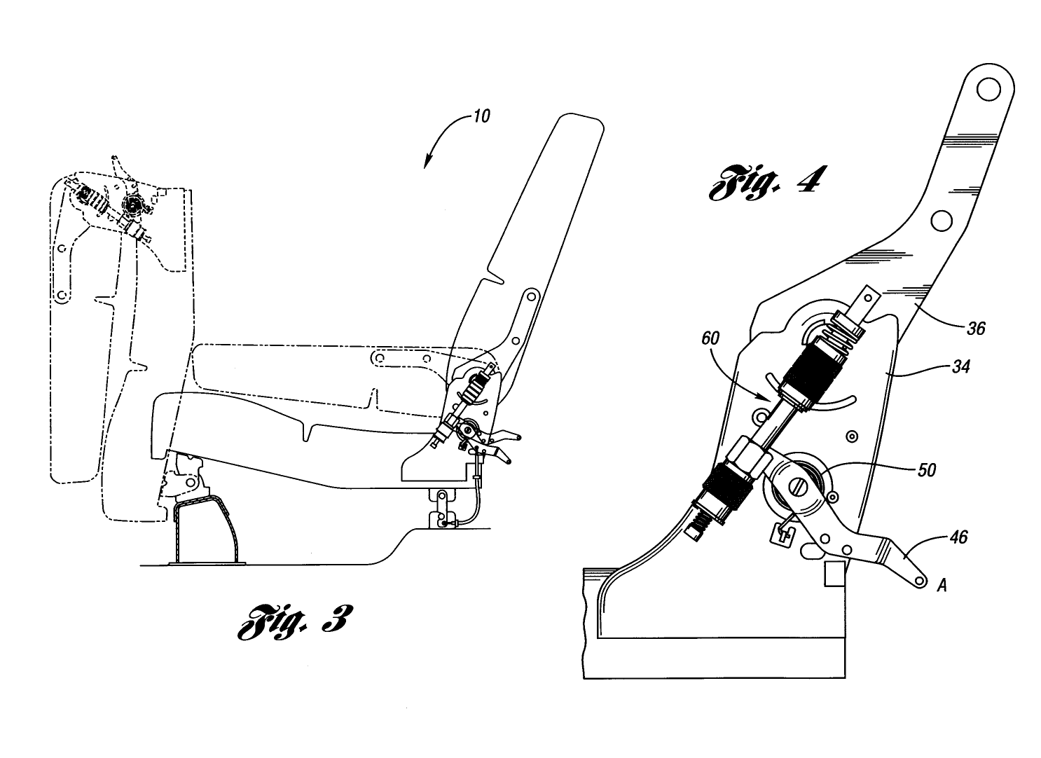

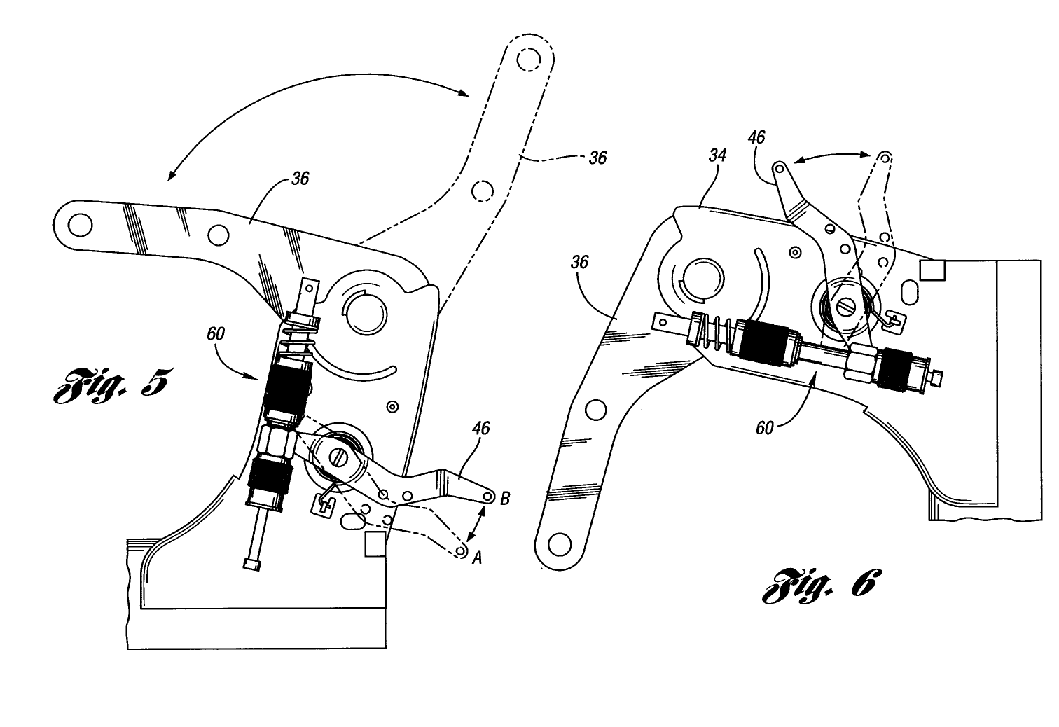

FIGS. 3-6 illustrate operation of the seat 10 in accordance with one non-limiting aspect of the present invention. The Figures show the seat 10 in the upright position (FIG. 4), the fold-flat position (FIG. 5), and the tumble position (FIG. 6). Access to each of the positions may be controlled, as described above, as a function of latch handle position. The latch handle position may generally be described with respect to an “A” position associated with the seat back being locked in an upright position, a “B” position associated with the seat back latch being release and the seat back free to rotate to the fold-flat position, and a “C” position associate with release of the rear floor latch and the seat back and bottom being free to rotate about the front floor support.

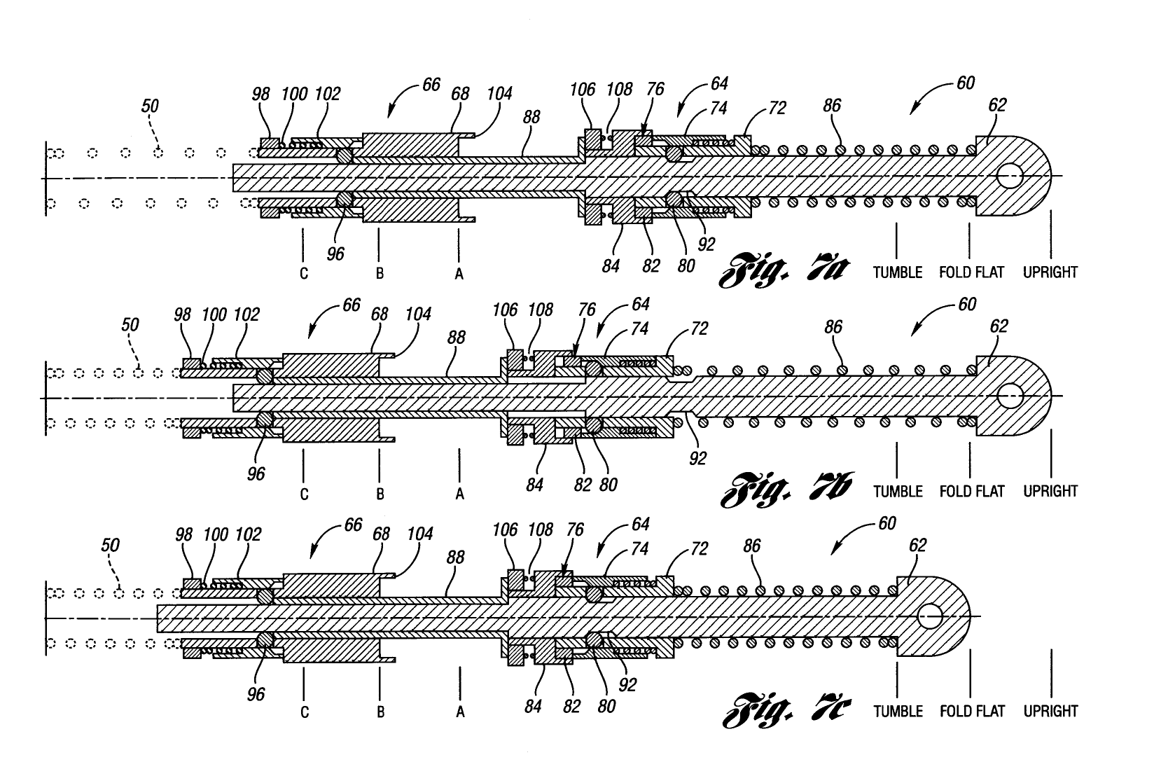

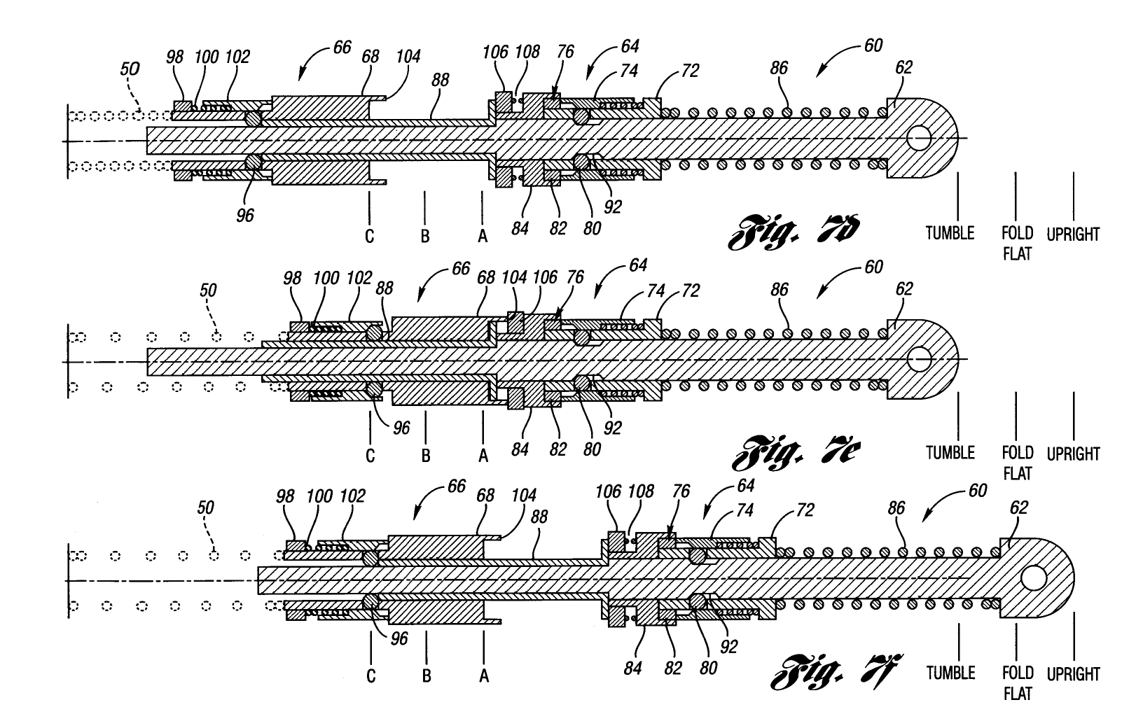

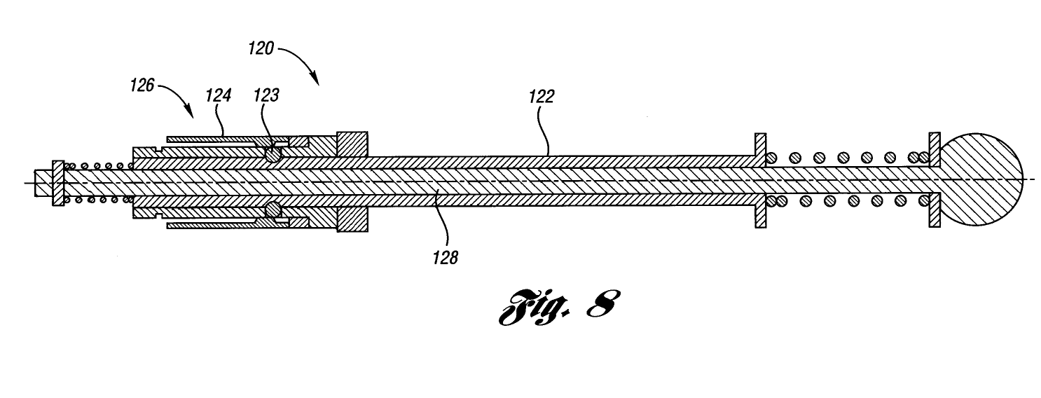

FIGS. 7a-7f illustrate the actuator 60 in accordance with one non-limiting aspect of the present invention. The actuator 60 may include a rod 62 generally configured to move linearly/axially relative to first and second release mechanisms 64-66. One end of the rod 62 may be connected to the seat back bracket 36 or other portion of the seat back 14 and an other end may be free to slide within the second release mechanism 66. The handle release mechanism 66, may be connected to a front portion of the latch handle 46 by way of a handle collar 68.

The rod 62 may move with the trigger release mechanism 64 and the handle release mechanisms 66 may move with the latch handle 46 to facilitate actuating the latch handle 46 and controlling movement of the seat 10 in accordance with the present invention. The first release mechanism 64 may fire to facilitate moving the handle release mechanism in a leftwardly direction to facilitate moving the handle from the A position to the B position, as described below in more detail. The second release mechanism 66 may similarly fire to facilitate moving the mechanism 66 in a rightwardly direction to facilitate moving the handle from the C position to the A position.

The trigger release mechanism 64 may include a reference collar 72, a slide collar 74, and a collar actuator 76, such as but not limited to the type described in U.S. patent application entitled “Rotational Based Actuator Configured to Impart Linear Movement,” filed on Apr. 13, 2007 and assigned Ser. No. ______, the disclosure of which is hereby incorporated in its entirety. The collar actuator 76 may be fired, through electrical stimulation or other control, to slide the slide collar 74 in a rightwardly direction to free a ball bearing 80 from the reference collar 72. As shown, a disk 82 within a housing 84 of the collar actuator 76 slides rightwardly in response to electrical stimulation and as described in the application noted above.

A spring 86 biased between the seat back connected end of the rod 62, upon freeing of the ball bearing 80, slides the trigger release mechanism 64 and a push collar 88 in a leftwardly direction along the rod 62. The push collar 88 contacts the handle release mechanism 66 to move the handle release mechanism 66 leftwardly by a similar distance. The leftward motion of the handle release mechanism 66 moves the handle 46 from the A position (FIG. 7a) to the B position (FIG. 7b). This movement frees the spring biased pivot 38 in the seat 10 to free the seat back 14 to begin rotating from the upright position to the fold-flat position. At this point, and as shown in FIG. 7b, the seat back 14 has not begun to rotate from the upright position as demonstrated by the end of the rod 62 remaining a the upright position.

After the trigger release mechanism 64 is fired and while the rod 62 remains in the upright position or close to it, the trigger release mechanism 64 is moved leftwardly of ball bearing receipt grooves 92 included in the rod 62. This allows the rod 62 to slide with in the trigger and handle release mechanisms 64-66. As the seat back 14 begins to rotate from the upright position, the rod 62 begins to slide within these features and move leftwardly as the seat back 14 rotates until the grooves 92 realign with the ball bearings 80. The realigned ball bearings 80 then drop back into the grooves 92 to re-lock the rod 62 with the trigger release mechanism 64, as shown in FIG. 7c, such that the locked rod 62 again forms a hard-bar linkage in so far as pressure applied to the seat back end results in pressure being applied to the handle release mechanism 66.

The folded-flat position corresponds with the handle 46 being located in the B position with the seat back latch 46 being disengaged and the floor latch 22 being engaged. The handle 46 must be moved from the B position to the C position in order to disengage the floor latch 22 and allow the seat 10 to continue moving to the tumble position. The spring 86 used to move the handle release mechanism 66 from the A position to the B position may be unable to apply sufficient force to continue moving the handle release mechanism 66 to the C position. The present invention contemplates this and relies on the ball bearings 80 to re-lock with the rod 62 and form the hard-bar linkage such that the seat back 14 in combination with the hard-bar linkage forms a momentum arm having sufficient force to continue moving the handle release mechanism 66 form the B position onto the C position, and thereby, disengage the floor latch 22 and allow the seat 10 to reach the tumble position.

FIG. 7d corresponds with the hard-bar linkage and the seat back momentum causing the rod 62 to continue to move leftwardly to a compressed position where the handle release mechanism 64 is pushed by the push collar 88 to the C position to allow the seat 10 to rotate forwardly to the tumble position. From the tumble position, the seat 10 may then be folded back to the fold-flat or upright positions. In order to return to either one of these positions, the floor latch 22 must be re-engaged, i.e., the handle 46 must be returned to the B position. The handle spring 50 (which for reference is shown in phantom) may provide sufficient force to reset the handle 46 to the A or B positions as the seat back 14 is folded back to those positions.

One problem contemplated by the present invention relates to activation of the collar actuator 76 while attempting to return the seat 10 from the tumble position. Activation of the collar actuator 76 during this time period can result in the first slide collar 74 freeing the first ball bearing 80 such that the spring is free to move the rod 62. This can lead to an imbalanced state. The present invention is able to prevent such an imbalanced state by preventing firing of the collar actuator 76. Turning to FIG. 7c, the handle release mechanism 66 may include, in addition to the handle collar 68, a ball bearing 96, clip ring 98, collar spring 100, and slide collar 102. The slide collar 102 may be slide leftwardly (with a cable, SMA element, or other non-illustrated feature) to free the ball bearing 96 from the handle collar 68 so as to allow the handle spring 50 to push the handle release mechanism 66 towards the right.

The rightward movement of the handle release mechanism 66 causes a tab 104 on the handle collar 66 to contact a control collar 106 on the collar actuator 76. This causes the control collar 106 to move rightwardly to electrically disconnect the disk 82 used to slide the first slide collar 74. The electrical disconnect of the disk 82 prevents firing of the trigger release mechanism 64, and thereby, the imbalanced state. Once the handle release mechanism 66 is fired, the seat back 14 can continue to be rotated to either one of the fold-flat or upright position. The rod 62 keeps moving rightwardly as the seat back 14 is folded to the upright position until it reaches the upright position, as shown in FIG. 7f. A spring 108 may be include to facilitate returning the control collar 106 to its electrically connected position.

FIG. 8 illustrates a single release mechanism actuator 120 in accordance with one non-limiting aspect of the present invention. The actuator 120 operates in a manner similar to that describe with respect to having a push collar 122 that fires upon freeing a ball bearing 123 with slide collar 124. A release mechanism 126 is fixed to the push collar 122 such that it slides along a rod 128 with the push collar 122. The rod 128 may thereafter be compressed to re-lock the release mechanism 126 to the rod 128.

As required, detailed embodiments of the present invention are disclosed herein; however, it is to be understood that the disclosed embodiments are merely exemplary of the invention that may be embodied in various and alternative forms. The figures are not necessarily to scale, some features may be exaggerated or minimized to show details of particular components. Therefore, specific structural and functional details disclosed herein are not to be interpreted as limiting, but merely as a representative basis for the claims and/or as a representative basis for teaching one skilled in the art to variously employ the present invention.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A linear actuator comprising:
a rod;
a first release mechanism connected to the rod and configured to move with movement of the rod when locked and free to slide along the rod and independently of the rod when unlocked; and
a second release mechanism connected to the rod and first release mechanism, the second release mechanism configured to move with movement of the first release mechanism when locked and free to slide along the rod and independently of the first release mechanism when unlocked.

2. The linear actuator of claim 1 further comprising a spring connected between the rod and first release mechanism to move the first release mechanism away from an end of the rod when fired.

3. The linear actuator of claim 1 further comprising a push collar connecting the first release mechanism to the second release mechanism, the second release mechanism configured to move with movement of the push collar when locked and free to slide along the push collar and independently of the push collar when unlocked.

4. The linear actuator of claim 1 wherein the first release mechanism includes an override collar configured to prevent unlocking of the first release mechanism when moved from a first position to a second position, the second release mechanism including a reference collar configured to move with the second release mechanism, the reference collar having a tab configured to move the override collar from the first position to the second position.

5. The linear actuator of claim 1 wherein the rod includes a groove for receiving a ball bearing of the first release mechanism, the ball bearing sliding out of the groove when the first release mechanism is unlocked and the ball bearing locking in the groove when the first release mechanism is locked, the actuator forming a hard-bar linkage when the ball bearing is locked within the groove.

6. A seat back actuator for use in actuating a seat from an upright position to a fold-flat position and finally to a tumble position, the seat having a seat back and seat bottom and a spring-biased pivot for pivotally connecting the seat bottom to seat back support and folding the seat forwardly from the upright position to the fold flat position depending on a positioning of a handle having a first position, a second position, and a third position, the first position locking the seat in the upright position, the second position allowing the pivot to fold the seat to the fold-flat position, and the third position disengaging a rear seat floor latch to allow a front support spring to rotate the seat to the tumble position, the seat back actuator comprising:
a rod connected at a first end to the seat back;
a first release mechanism connected to the rod and biased away from the first end of the rod with a first power spring, the first release mechanism configured to move with movement of the rod when locked and to slide along the rod with the first power spring and independently of the rod when unlocked;
a second release mechanism connected to the handle and the first release mechanism, the second release mechanism configured to move with movement of the first release mechanism when locked and free to slide along the rod and independently of the first release mechanism when unlocked; and
wherein folding the seat from the upright position to the fold-flat position and onto the tumble position sequentially includes:
(i) unlocking the first release mechanism to allow the first power spring to move the second release mechanism a sufficient distance to cause the second release mechanism to move the handle from the first position to the second position, thereby folding the seat from the upright position to the fold-flat position; and
(ii) relocking the first release mechanism with rotation of the seat back causing the rod to slide within the first release mechanism until a hard-bar linkage is formed and momentum generated by the rotate seat back provides sufficient force to move the second release mechanism a sufficient distance to cause the second release mechanism to move the handle from the second position to the third position, thereby folding the seat from the fold-flat position to the tumble position.

7. The seat back actuator of claim 6 wherein returning the seat from the tumble position to the fold-flat position includes:
after step (ii) in claim 6, unlocking the second release mechanism to free the second release mechanism to slide along the rod and independently of the first release mechanism in order to allow a handle spring connected between the handle and the seat back to move the second release mechanism a sufficient distance to return the handle from the third position to the second position, thereby allowing re-engagement of the floor latch and returning of the seat from the tumble position to the fold-flat position.

8. The seat back actuator of claim 7 wherein returning the seat from the fold-flat position to the tumble position includes:
after returning the seat to the fold-flat position in claim 7, with rotation of the seat back and the hard-bar linkage from the fold-flat position towards the upright position, retracting the rod through the second release mechanism until the second release mechanism locks, the handle spring restraining movement of the second release mechanism to facilitate locking the second release mechanism.

9. The seat back actuator of claim 7 wherein the first release mechanism includes an override collar configured to prevent unlocking of the first release mechanism when moved from a first position to a second position, the second release mechanism including a reference collar configured to move with the second release mechanism, the reference collar having a tab configured to move the override collar from the first position to the second position when the handle spring causes the second release mechanism to move a sufficient distance towards the first release mechanism.

10. A seat comprising:
a back;
a bottom;
a spring biased pivot connecting the back to the bottom and configured to rotate the back from an upright position to a fold-flat position;
a latch system having a latch and a handle, the latch configured to prevent rotation of the back relative to the bottom when engaged and to free rotation of the back relative to the bottom when disengage, the handle connect to the latch to facilitate engaging and disengaging the latch, the handle having a first position to engage the latch and a second position to disengage the latch;
a front and rear support configured to support the bottom, the rear support having a floor latch configured to secure a rear portion of the bottom to the floor support when engaged and to free the rear portion from the floor support when disengaged, the handle having a third position associated with disengaging the floor latch, the front support including a spring biased pivot configured to rotate the bottom from the fold-flat position to an upright position when the floor latch is disengaged; and
a linear actuator configured to move the handle between the first, second, and third positions so as to facilitate folding the seat from the upright position to the fold-flat position and onto the tumble position.

11. The seat of claim 10 wherein the linear actuator further includes:
a rod connected at a first end to the seat back;
a first release mechanism connected to the rod and biased away from the first end of the rod with a first power spring,;
a second release mechanism connected to the handle and the first release mechanism; and
wherein folding the seat from the upright position to the fold-flat position and onto the tumble position sequentially includes:
(i) unlocking the first release mechanism to allow the first power spring to move the second release mechanism a sufficient distance to cause the second release mechanism to move the handle from the first position to the second position, thereby folding the seat from the upright position to the fold-flat position; and
(ii) relocking the first release mechanism with rotation of the seat back causing the rod to slide within the first release mechanism until a hard-bar linkage is formed and momentum generated by the rotate seat back provides sufficient force to move the second release mechanism a sufficient distance to cause the second release mechanism to move the handle from the second position to the third position, thereby folding the seat from the fold-flat position to the tumble position.

12. The seat of claim 11 wherein returning the seat from the tumble position to the fold-flat position includes:
unlocking the second release mechanism to free the second release mechanism to allow a handle spring connected between the handle and the seat back to move the second release mechanism a sufficient distance to return the handle from the third position to the second position, thereby allowing re-engagement of the floor latch and returning of the seat from the tumble position to the fold-flat position.

13. The seat of claim 12 wherein returning the seat from the old-flat position to the tumble position includes:
with rotation of the seat back and the hard-bar linkage from the old-flat position towards the upright position, retracting the rod through the second release mechanism until the second release mechanism locks, the handle spring restraining movement of the second release mechanism to facilitate locking the second release mechanism.
